(19) United States
(12) Patent Application Publication
(10) Pub. No.: US 2007/0147497 A1
(43) Pub. Date: Jun. 28, 2007

(54) System and method for progressive quantization for scalable image and video coding

(75) Inventors: Yiliang Bao, Irving, TX (US); Marta Karczewicz, Irving, TX (US); Justin Ridge, Irving, TX (US); Xianglin Wang, Irving, TX (US)

Correspondence Address: FOLEY & LARDNER LLP, P.O. BOX 80278, SAN DIEGO, CA, 92138-0278, US

(73) Assignee: Nokia Corporation

(21) Appl. No.: 11/490,802

(22) Filed: Jul. 21, 2006

Related U.S. Application Data
(60) Provisional application No. 60/701,172, filed on Jul. 21, 2005.

(51) Int. Cl. H04N 11/04; H04N 7/12

(52) U.S. Cl. 375/240.03; 375/240.26

(57) ABSTRACT

An improved system and method for dequantizing progressively quantized signals in scalable image and video coding. A decoder performs simple dequantization, such as normal uniform dequantization, on coded content using a quantization index and a nominal quantization step size to obtain a nominal reconstruction level. The result is then adjusted by adding the reconstruction offset to obtain the final reconstruction value.

### CROSS-REFERENCE TO RELATED APPLICATIONS

This application claims priority to United States Provisional Patent Application No. 60/701,172, filed Jul. 21, 2005 and incorporated herein by reference in its entirety.

### FIELD OF THE INVENTION

The present invention related generally to video coding and image coding. More particularly, the present invention relates to scalable video coding and scalable image coding.

### BACKGROUND OF THE INVENTION

Quantization is an important step in video coding. Quantization is a process by which each sample in a video signal is rounded to one of a finite number of values. By changing the quantization parameters, one can control both the bit-rate and the quality of the compressed video. The quantization and dequantization processes defined in typical video coding standards can be explained using the following equations.

$$\begin{matrix}Q ( x ) = sign ( x ) \cdot floor ( \vert x \vert / q + f ) & ( 1 ) \\ R ( x ) = q \cdot ( Q ( x ) + g ) & ( 2 )\end{matrix}$$

A Function floor (y) gives the largest integer number that is smaller than or equal to y. In equations (1) and (2), x is the original transform coefficient; Q(x) is the quantized transform coefficient; R(x) is the reconstructed transform coefficient; q is the quantization step size; f is the rounding offset; and g is the reconstruction offset.

FIG. 1 is an illustration of a general example of the quantization/dequantization process, where both f and g are non-zero. In the quantization process, the coefficients falling within the same quantization interval are quantized to the same value. After the dequantization, all of coefficients will have the same reconstruction value. The boundaries of the quantization intervals are referred to as decision levels. The difference between the original value and the reconstructed value is commonly referred to as the quantization error. The center interval that corresponds to the quantized value of 0 is referred to as the deadzone, and other intervals are referred to as refinement intervals.

The quantization/dequantization processes in different standards may use different values for f and g. For example, in the H.264 video codec, the encoder can vary f, normally within the range between 0 and 1/2 , in order to obtain an optimal coding performance, and g is always equal to 0. Such a quantizer is illustrated in FIG. 2. In this particular example, a rounding offset of 1/3 is used. For example, with the quantization interval [2q/3, 5q/3), all of the coefficients in this interval are quantized to 1. At the decoder side, a quantized coefficient of value 1 is reconstructed to q. For the quantization interval [2q/3, 5q/3), the quantization error of a coefficient is in the range of [−q/3, 2q/3). In contrast, the H.263 video codec has a slightly different quantizer. In the H.263 video codec, is normally 0, and g is always equal to ½. This quantizer is illustrated in FIG. 3.

A signal-to-noise ratio (SNR) scalable video stream has the property that the video of a lower quality level can be reconstructed from a partial bitstream. With this feature, a device can properly reconstruct a video, but at a lower quality, if it only decodes part of the bitstream due to some limitations such as channel bandwidth or processing power.

One method of generating a SNR scalable video bitstream involves generate a base layer using a normal non-scalable video coder, such as a H.264 encoder, and then generating the enhancement layers with additional coding tools. Such an approach is particularly important because of the backward compatibility consideration. This approach is also taken by the International Telecommunication Union's Joint Video Team (JVT) in developing new scalable video coding standard. The latest reference software, Joint Scalable Video Model version 2.0 (JSVM2), has just been released. JSVM2 is able to generate a scalable video stream including an Advanced Video Coding (AVC)-compliant base layer and additional enhancement layers, such as a spatial enhancement layer, a coarse granularity SNR enhancement layer, and a fine granularity SNR enhancement layer.

Conventionally, the quantizer used in SNR enhancement layer coding is similar to that used in base layer coding. For example, JSVM2 uses the same quantizer in both base layer and SNR enhancement layer coding. JSVM2 simply quantizes the error signal resulting from the base layer coding with smaller qp. This approach is referred to as re-quantization and is illustrated at the left side of FIG. 4. Also in FIG. 4, the single layer quantization with the quantization parameter step size of q/2 is drawn for comparison. As can be seen in FIG. 4, re-quantization generates intervals of varying sizes. In addition, the reconstructed levels are usually not well positioned. The reason for such non-uniform quantization results is that the decision levels of the base layer and the enhancement layer quantizer are not aligned.

One method of generating more uniform quantization intervals is to perform what is referred to as “embedded quantization.” In embedded quantization, decision levels of a coarse-scale quantizer are always aligned with the decision levels of a fine-scale quantizer. In one design of such a quantizer, a base layer refinement interval is split into two halves of equal size of q/2, and the deadzone is split into three interval including two new refinement intervals and the new deadzone. Two new refinement intervals have the size of q/2 that is the same as that of other refinement intervals. Such an embedded quantizer is illustrated in FIG. 5.

The advantage of quantization methodology depicted in FIG. 5 is that it always generates refinement intervals of the same size. However, the size of the new deadzone directly depends upon the initial rounding offset used in the base layer quantization. If the base layer uses a relatively large rounding offset, then the deadzone in the enhancement layer could be very small. In FIG. 5, a rounding offset of 1/3 is used in the base layer quantization. The deadzone in the enhancement layer quantization becomes 2/3 in the scale of q/2. This deadzone is much smaller than a refinement interval. This could result in sub-optimal performance because too many coefficients are quantized to non-zero values. This deadzone is so small that it cannot even be further split using the same method in coding the next FGS layer. This will result in a non-smooth FGS rate-distortion curve.

### SUMMARY OF THE INVENTION

The present invention provides for a flexible dequantizer design for use in SNR enhancement layer coding. In the present invention, the decoder performs the normal uniform dequantization of a coefficient based upon the quantization index and the nominal quantization step size in order to obtain a nominal reconstruction level. The nominal quantization step size may not be the same as the actual quantization step size used in the quantization process. The decoder then adjusts the result by adding the reconstruction offset in order to obtain the optimal reconstruction level for a coefficient. The best reconstruction levels are calculated at the encoder side and the reconstruction offsets, which are calculated as the differences between the optimal reconstruction levels and the nominal reconstruction levels, are transmitted to the decoder. The reconstruction offset is dependent on the quantization index. It is also dependent on the classification of the coefficients. For example, luminance and chrominance signals can have their own set of reconstruction offsets so that luma and chroma coefficients can be quantized differently. With the present invention, an efficient methodology is used to code the reconstruction offsets so that the coding overhead on these numbers is minimal.

The present invention provides for a number of important advantages over conventional approaches. One major problem with the conventional requantization systems is that the refinement intervals are improperly handled. Although using embedded quantization solves this problem, the simple embedded quantization methodology possesses inflexibility in splitting the deadzone. In contrast, with this invention, the design of the dequantizer allows the quantizer to treat the refinement intervals as they are treated in embedded quantization. In addition, the quantizer can perform optimal splitting of the deadzone to obtain the best coding performance.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an illustration of linear quantization with a non-zero rounding offset and non-zero reconstruction offset;

FIG. 2 is an illustration of linear quantization that has a nonzero rounding offset and zero reconstruction offset in accordance with the H.264 video codec;

FIG. 3 is an illustration of linear quantization that has zero rounding offset and 1/2 reconstruction offset in accordance with the H.263 video codec;

FIG. 4 is an illustration comparing re-quantization to single-layer quantization;

FIG. 5 is an illustration of embedded quantization with refinement intervals of equal size and an adaptive quantizer with optimal deadzone splitting;

FIG. 6 shows the processes of quantization and dequantization in an adaptive quantizer according to the principles of the present invention;

FIG. 7 is a flow chart showing the implementation of one embodiment of the present invention.

FIG. 8 is a perspective view of a mobile telephone that can be used in the implementation of the present invention; and

FIG. 9 is a schematic representation of the telephone circuitry of the mobile telephone of FIG. 8.

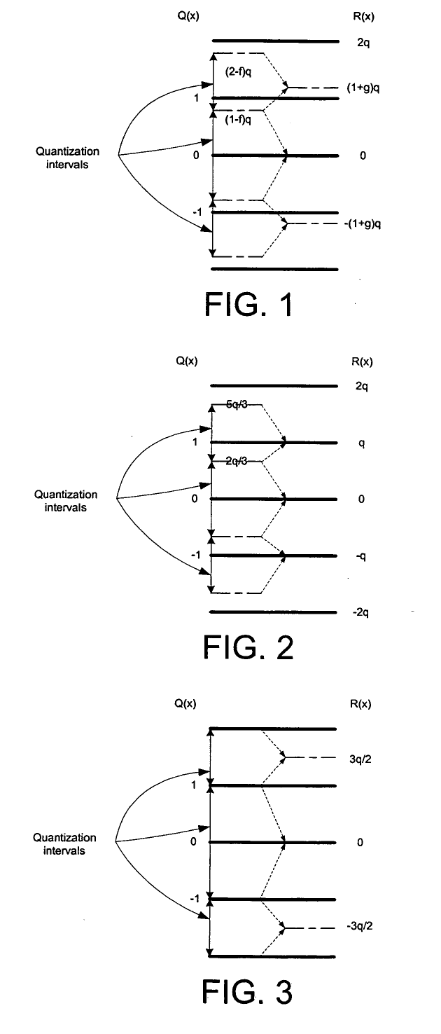

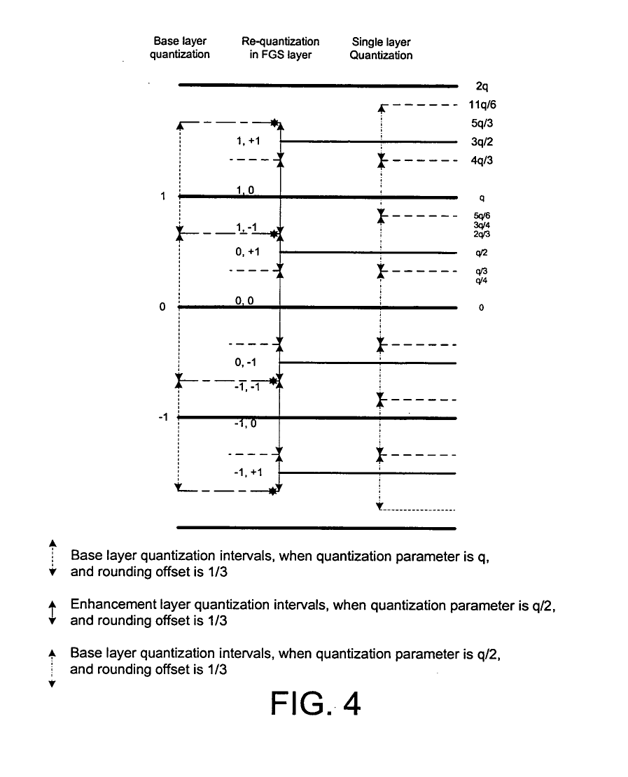

### DETAILED DESCRIPTION OF THE PREFERRED EMBODIMENTS

The present invention provides for a design of a dequantizer, as well as an exemplary quantizer used in the coding of SNR enhancement layers, particularly Fine Granularity Scalability (FGS) SNR enhancement layers. In the present invention, the decoder performs a process similar to uniform dequantization based upon the quantization index and nominal quantization step size in order to obtain a nominal reconstruction level. The decoder adjusts the result by adding the reconstruction offset. The best reconstruction levels are calculated at the encoder side and the reconstruction offsets, which are calculated as the differences between the optimal reconstruction levels and the nominal reconstruction levels, are transmitted to the decoder. The reconstruction offset is dependent upon the quantization index. With the present invention, an efficient methodology is used to code the reconstruction offsets so that the coding overhead on these numbers is minimal. Luminance and chrominance signals can have their own sets of reconstruction offsets so that luma and chroma coefficients can be quantized differently. Luma is a component which represents lightness, while chroma comprises two components that represent color, disregarding lightness.

The dequantizer can be extended. Coefficients can be classified into more categories instead of just being separated into luma and chroma coefficients to allow for more flexibility in the base layer quantizer design.

In the present invention, the coefficients can be first classified into coefficient sets based upon the color component, transform type and frequency. The sets of the coefficients are categorized into groups based upon the statistics of each coefficient set. The grouping information as well as the optimal reconstruction offsets for each group is signaled.

With the present invention, the enhancement layer quantizer can perform optimal splitting of the deadzone resulting from base layer quantization in order to achieve the optimal coding performance. This flexibility in splitting the deadzone also allows for much-needed control on the bit rate. The deadzone of luma and chroma coefficients can be differently split to have the optimal balance between luma and chroma quality.

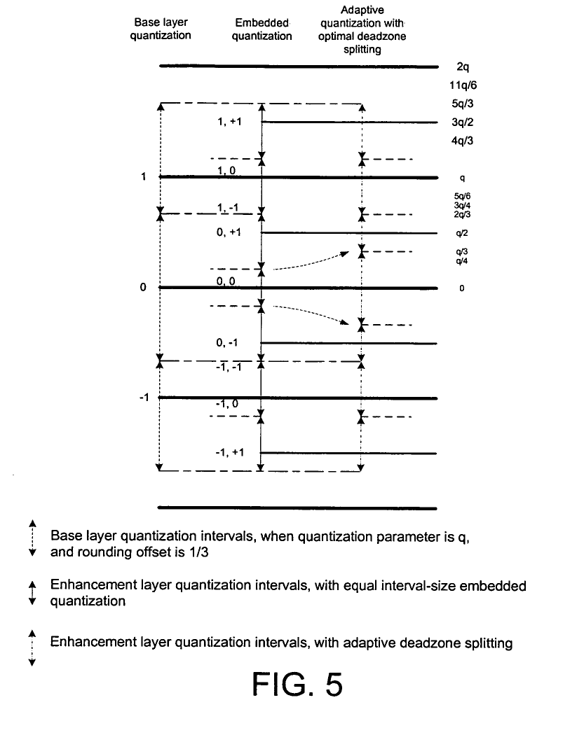

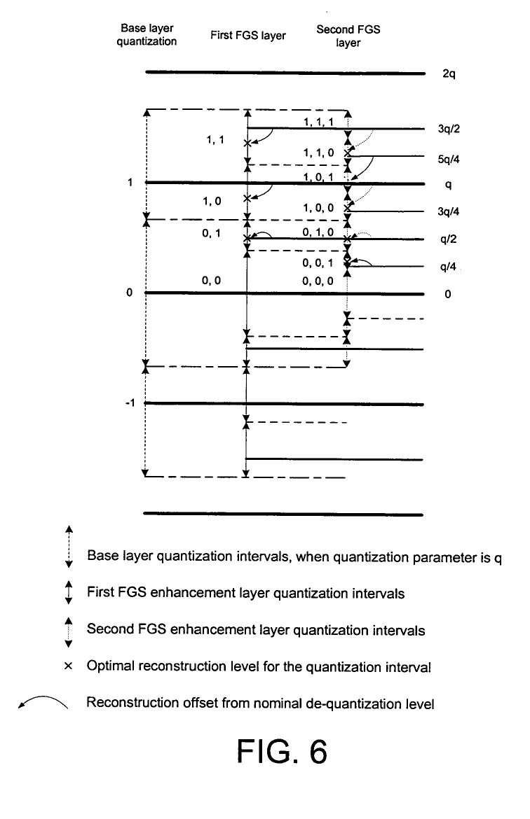

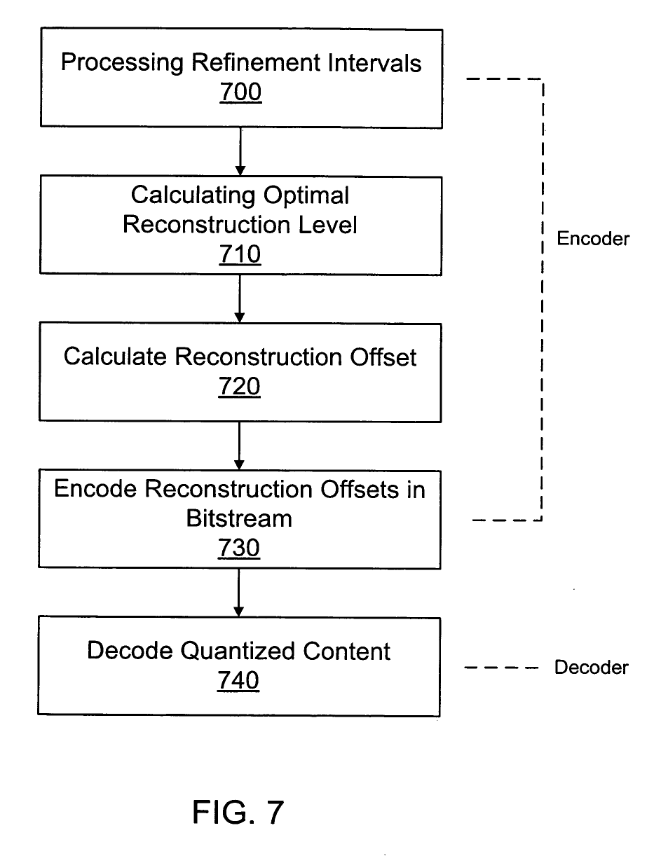

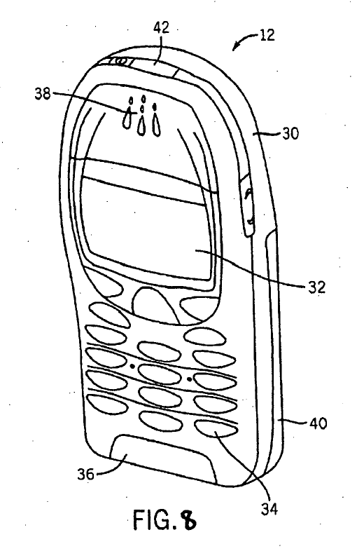

A process of implementation of one embodiment of the present invention is depicted generally in FIG. 7. Although the present invention is primarily addresses the dequantizer design, the quantizer design is also discussed. This quantizer is referred to as an adaptive quantizer. At step 700, the adaptive quantizer processes the refinement intervals in a similar manner as the embedded quantizer. The adaptive quantizer can split the deadzone in a way to provide the optimal coding performance. FIG. 5 shows the difference between the adaptive quantizer and the embedded quantizer. The only difference is how the deadzone is split. However, the dequantizer can possess a more flexible design than the quantizer. For example, the dequantizer does not even require that the refinement interval is split into two halves of equal size, or into two halves at all.

After quantization and at step 710, the adaptive quantizer calculates the optimal reconstruction level for each quantization interval. The reconstruction offset is calculated at step 720 as the difference between the optimal reconstruction level and the nominal reconstruction level that is calculated from the quantization index and nominal quantization step size. The reconstruction offsets are coded in the bitstream at step 730. The decoder then decodes quantized content at step 740 by performing some simple dequantizaton such as uniform reconstruction to obtain the nominal reconstruction level and adding the reconstruction offset.

In an exemplary implementation of the present invention, the reconstruction offsets can be transmitted at the frame level or the slice level. Specifically, for the implantation in SVC, which is based upon H.264, the reconstruction offsets can be transmitted in the slice header of an FGS slice. In the syntax description below, a slice of slice type “PR” is an FGS slice (progressive refinement.) The syntax for the coding of reconstruction offsets is as follows:

| | | C | Descriptor |
|---|---|---|---|
| slice_header_in_scalable_extension( ) { | | | |
| | ...... | | |
| | if( slice_type == PR ) { | | |

| | | |
|---|---|---|
| recon_offset_bit_depth | 2 | u(4) |
| recon_offset_shift_bits_plus_3 | 2 | u(3) |
| recon_offset_all_non_positve_flag | 2 | u(1) |
| recon_offset_shift_bits = recon_offset_shift_bits_plus_3 − 3 | | |
| recon_offsets( luma_recon_offsets_arr, num_luma_recon_offsets ) | | |
| recon_offsets( chroma_rec_offsets_arr, num_chroma_recon_offsets) | | |

| | } | |
|---|---|---|
| recon_offsets ( recon_offsets_arr, num_recon_offsets ) { | | |
| | num_recon_offsets | u(4) |
| | for( i = 1; i <= num_recon_offsets; i ++ ) { | |

| | | |
|---|---|---|
| recon_offset | 2 | u(v) |
| if (recon_offsets_arr [num_recon_offsets] == 0 ) | | |

recon_offsets_arr [num_recon_offsets] == ILLEGAL_RECON_OFFSET

else

recon_offsets_arr [num_recon_offsets] =

recon_offset − ( 1 << recon_offset_bit_depth) + 1

}

The semantics for coding of reconstruction offsets is as follows.

recon_offset_bit_depth is used to indicate how many bits are needed to represent the absolute value of one reconstruction offset.

recon_offset_shift_bits plus_{—}3 is used to indicate the precision of the reconstruction offset. The normalized reconstruction offset is recon_offset_fixed/(1<<(recon_offset_bit_depth _recon_offset_shift_bits)).

num_recon_offsets indicates how many reconstruction offsets are stored for this group of coefficients.

recon_offset is the reconstruction offset. The number of bits to be read is recon_offset_bit_depth if the recon_offset_all_non_positive_flag is 1. The number of bits to be read is recon_offset_bit_depth+1 if the recon_offset_all_non_positive_flag is 0. A recon_offset of value 0 indicates that the corresponding quantization index is not valid and should not be encountered during the decoding process. The actual reconstruction offset is converted from recon_offset using the equation: recon_offsets_arr[num_recon_offsets]=recon₁₃ offset-(1<<recon_offset_bit_depth)+1

If the quantization index decoded from the bitstream is too large and the corresponding reconstruction offset is not found in the lookup table, then the last valid reconstruction offset should be used.

Handling closeloop in FGS coding. Normally in the coding of a coefficient in an FGS layer, only collocated information in the base layer reconstructed frame is used as the prediction. If a different prediction is used, e.g, by performing motion compensation in the FGS layer, an original signal which is a coefficient calculated from the prediction residuals may not be confined within the previous quantization interval, and value of the refinement coefficient is no longer limited to 0 or 1. In the present invention, the refinement information is not limited to 0 or 1 if closeloop is supported. A flag can be transmitted to the decoder so that the decoder can perform entropy decoding and dequantizatoin accordingly. The coefficient can transit to a different interval if the refinement information is not either 0 or 1. The reconstruction offset to the coefficient also depends upon the value of the refinement coefficient.

Non-valid reconstruction offset. A non-valid reconstruction offset is explicitly signaled. Some quantization indices may not be decoded from the bitstream at all. This could occur when the encoder chooses not to split some intervals. In one embodiment of the present invention, non-valid reconstruction offsets can be used for detecting the error in the decoding process caused by either the error in the bitstream or a problem in decoder implementation. If the decoder decodes a quantization index that has a non-valid reconstruction offset, an error has occurred. When a reconstruction offset for a coefficient is not valid, it means that the corresponding quantization interval in the base layer is not split in the enhancement layer. In one embodiment of the invention, no refinement information corresponding this interval needs to be coded. The same is true for the deadzone. The deadzone is normally split into a definite number of new intervals (normally three intervals). The non-valid reconstruction offset can also be used in signaling how the deadzone is actually split. The quantization index for the interval in the enhancement layer is inferred from base layer quantization index if the quantization index has a non-valid reconstruction offset.

Adjustment of chroma quality with respect to luma. In the H.264 video codec, the quantization parameter used for coding the chrominance signals is different from that for coding the luminance signals. In this discussion, chroma_qp_index_offset, an additional parameter that controls the mapping process, is not considered and is assumed to always be 0. The following lookup table is used for deriving chroma qp QPc from luma qp Qpy. It should be noted that, instead of using a normal quantization step size, the H.264 codec uses a quantization parameter from which the quantization step size q can be derived.

q = c*exp(qp/6)

| | QP_{Y} | | | | | | | | | | | | | | | | | | | | | | |
|---|---|---|---|---|---|---|---|---|---|---|---|---|---|---|---|---|---|---|---|---|---|---|---|
| | <30 | 30 | 31 | 32 | 33 | 34 | 35 | 36 | 37 | 38 | 39 | 40 | 41 | 42 | 43 | 44 | 45 | 46 | 47 | 48 | 49 | 50 | 51 |
| QP_{C} | =QP_{Y} | 29 | 30 | 31 | 32 | 32 | 33 | 34 | 34 | 35 | 35 | 36 | 36 | 37 | 37 | 37 | 38 | 38 | 38 | 39 | 39 | 39 | 39 |

In this situation, if base layer is coded at a QPy of 43, then the chroma qp QPc of value 37 should be used. The luma qp used in FGS enhancement layer coding is 37 (=43−6) because the quantization step size in the enhancement layer is usually half of that in the base layer. If chroma is treated the same as luma in FGS layer quantization, then the chroma qp used in the enhancement layer will be 31 (37−6). This is much smaller than 34, which is mapped from luma qp of 37.

In the present invention, chroma reconstruction offsets can be different from luma reconstruction offsets. This makes it possible to quantize luma and chroma differently in the enhancement layer. For example, the rounding offset used in quantizing the chroma can be set smaller than that used in quantizing the luma. With proper adjustment on the rounding offsets, a quality balance between luma and chroma that is similar to that in the H.264 base layer can also be achieved in the enhancement layer.

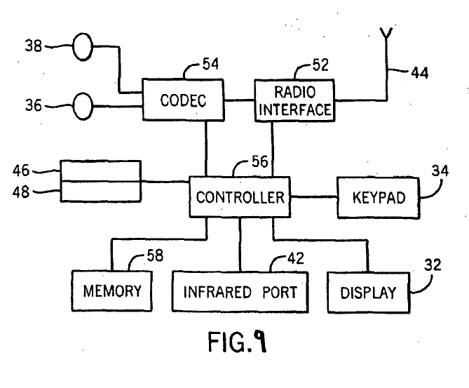

FIGS. 7 and 8 show one representative mobile telephone 12 within which the present invention may be implemented. It should be understood, however, that the present invention is not intended to be limited to one particular type of mobile telephone 12 or other electronic device. The mobile telephone 12 of FIGS. 7 and 8 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. The present invention can be implemented directly in software using any common programming language, e.g. C/C++ or assembly language. This invention can also be implemented in hardware and used in consumer devices. It should also be noted that the words “component” and “module” as used herein and in the claims is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of processing scalable content coding, comprising:
quantizing a scalable content portion to create a plurality of quantization intervals, the quantization including the calculation of an optimal reconstruction level for each quantization interval;
determining a reconstruction offset for each quantization interval, the reconstruction offset comprising the difference between a nominal reconstruction level and the optimal construction interval; and
coding the reconstruction offset for each quantization interval in a bitstream containing the quantized content.

2. The method of claim 1, wherein the scalable content comprises video content.

3. The method of claim 1, wherein the scalable content comprises image content.

4. The method of claim 1, wherein the nominal reconstruction level is calculated from a quantization index and a nominal quantization step size using simple dequantization.

5. The method of claim 4, wherein the simple dequantization comprises uniform reconstruction dequantization.

6. The method of claim 1, wherein the plurality of quantization intervals includes a deadzone interval, and wherein the deadzone interval can be split in the calculation of the optimal reconstruction level in a manner to produce an optimal coding performance.

7. The method of claim 1, wherein the reconstruction offsets for the plurality of quantization intervals include a set of luma reconstruction offsets and a set of chroma reconstruction offsets.

8. The method of claim 1, wherein the luma reconstruction offsets are permitted to be different than the chroma reconstruction offsets.

9. The method of claim 1, further comprising dequantizing the quantized scalable content using the reconstruction offsets transmitted in the bitsteam.

10. The method of claim 1, wherein the dequantization comprises, for each quantization interval, generating a nominal reconstruction offset level from a quantization index and a nominal quantization step size, and then adding the reconstruction offset.

11. A computer program product for processing scalable content coding, comprising:
computer code for quantizing a scalable content portion to create a plurality of quantization intervals, the quantization including the calculation of an optimal reconstruction level for each quantization interval;
computer code for determining a reconstruction offset for each quantization interval, the reconstruction offset comprising the difference between a nominal reconstruction level and the optimal construction interval; and
computer code for coding the reconstruction offset for each quantization interval in a bitstream containing the quantized content.

12. The computer program product of claim 11, wherein the scalable content comprises video content.

13. The computer program product of claim 11, wherein the scalable content comprises image content.

14. The computer program product of claim 11, wherein the nominal reconstruction level is calculated from a quantization index and a nominal quantization step size using simple dequantization.

15. The computer program product of claim 14, wherein the simple dequantization comprises uniform reconstruction dequantization.

16. The computer program product of claim 11, wherein the plurality of quantization intervals includes a deadzone interval, and wherein the deadzone interval can be split in a manner to produce an optimal coding performance.

17. The computer program product of claim 11, wherein the reconstruction offsets for the plurality of quantization intervals include a set of luma reconstruction offsets and a set of chroma reconstruction offsets, and wherein the chroma reconstruction offset is determined at least in part based upon the luma reconstruction offset.

18. The computer program product of claim 11, wherein the luma reconstruction offsets are permitted to be different than the chroma reconstruction offsets.

19. An electronic device, comprising:
a processor; and
a memory unit operatively connected to the processor and including:
computer code for quantizing a scalable content portion to create a plurality of quantization intervals, the quantization including the calculation of an optimal reconstruction level for each quantization interval,
computer code for determining a reconstruction offset for each quantization interval, the reconstruction offset comprising the difference between a nominal reconstruction level and the optimal construction interval, and
computer code for coding the reconstruction offset for each quantization interval in a bitstream containing the quantized content.

20. The electronic device of claim 19, wherein the nominal reconstruction level is calculated from a quantization index and a nominal quantization step size using simple dequantization.

21. The electronic device of claim 19, wherein the plurality of quantization intervals includes a deadzone interval, and wherein the deadzone interval can be split in the calculation of the optimal reconstruction level in a manner to produce an optimal coding performance.

22. The electronic device of claim 19, wherein the reconstruction offsets for the plurality of quantization intervals include a set of luma reconstruction offsets and a set of chroma reconstruction offsets, and wherein the chroma reconstruction offsets are determined at least in part based upon the luma reconstruction offsets.

23. A method of dequantizing scalable content, comprising:
receiving a bitstream, the bitstream capable of being decoded into a plurality of quantization indices each having a reconstruction offset and a nominal reconstruction level; and
for each quantization index, obtaining a final reconstruction value by adding the reconstruction offset to the nominal reconstruction level,
wherein the reconstruction offset comprises the difference between a calculated nominal reconstruction level and a calculated optimal construction interval.

24. The method of claim 23, wherein the nominal reconstruction level is calculated from the quantization index and the nominal quantization step size using simple dequantization.

25. The method of claim 23, wherein the simple dequantization comprises uniform reconstruction dequantization.

26. The method of claim 23, wherein quantization indices of certain values do not occur in the decoding process, and wherein, for each of the non-occuring quantization indices correspond to one non-valid reconstruction offset decoded from the bitstream.

27. The method of claim 23, wherein the non-valid reconstruction offset can be use din detecting decoding error if a quantization index corresponding to the non-valid reconstruction offset occurs during decoding.

28. The method of claim 23, wherein the non-valid reconstruction offset can be used to avoid encoding unnecessary decision flags in entropy coding.

29. The method of claim 23, wherein the scalable content comprises video content.

30. The method of claim 23, wherein the scalable content comprises image content.

31. The method of claim 23, wherein the reconstruction offsets include a set of luma reconstruction offsets and a set of chroma reconstruction offsets.

32. The method of claim 23, wherein the luma reconstruction offsets are permitted to be different than the chroma reconstruction offsets.

33. A computer program product for dequantizing scalable content, comprising:
computer code for receiving a bitstream, the bitstream capable of being decoded into a plurality of quantization indices each having a reconstruction offset and a nominal quantization level; and
computer code for each quantization index, obtaining a final reconstruction value by adding the reconstruction offset to the nominal reconstruction level,
wherein the reconstruction offset comprises the difference between a calculated nominal reconstruction level and a calculated optimal construction interval.

34. The computer program product of claim 33, wherein the simple quantization comprises uniform reconstruction dequantization.

35. The computer program product of claim 33, wherein quantization indices of certain values do not occur in the decoding process, and wherein, for each of the non-occuring quantization indices correspond to one non-valid reconstruction offset decoded from the bitstream.

36. The computer program product of claim 33, wherein the scalable content comprises video content.

37. The computer program product of claim 33, wherein the scalable content comprises image content.

38. The computer program product of claim 33, wherein the reconstruction offsets include a set of luma reconstruction offsets and a set of chroma reconstruction offsets.

39. The computer program product of claim 33, wherein the luma reconstruction offsets are permitted to be different than the chroma reconstruction offsets.

40. An electronic device, comprising:
a processor; and
a memory unit operatively connected to the processor and including a computer program product for dequantizing scalable content, comprising:
computer code for receiving a bitstream, the bitstream capable of being decoded into a plurality of quantization indices each having a reconstruction offset and a nominal quantization level; and
computer code for each quantization index, obtaining a final reconstruction value by adding the reconstruction offset to the nominal reconstruction level,
wherein the reconstruction offset comprises the difference between a calculated nominal reconstruction level and a calculated optimal construction interval.

41. The electronic device of claim 40, wherein the simple quantization comprises uniform reconstruction dequantization.

42. The electronic device of claim 40, wherein quantization indices of certain values do not occur in the decoding process, and wherein, for each of the non-occuring quantization indices correspond to one non-valid reconstruction offset decoded from the bitstream.

43. The electronic device of claim 40, wherein the reconstruction offsets include a set of luma reconstruction offsets and a set of chroma reconstruction offsets.

44. The electronic device of claim 40, wherein the luma reconstruction offsets are permitted to be different than the chroma reconstruction offsets.

45. The electronic device of claim 40, wherein the scalable content comprises video content.

46. The electronic device of claim 40, wherein the scalable content comprises image content.
